(19) United States
(12) Patent Application Publication
(10) Pub. No.: US 2025/0029504 A1
(43) Pub. Date: Jan. 23, 2025

(54) METHODS AND SYSTEMS FOR INTUITIVE HOT SPOT DEMARCATION

(71) Applicant: The Boeing Company, Arlington, VA (US)

(72) Inventors: Akshay Sankeshwari, Arlington, VA (US); Umesh Hosamani, Arlington, VA (US)

(21) Appl. No.: 18/353,999

(22) Filed: Jul. 18, 2023

(51) Int. Cl. G08G 5/04; B64D 45/00; G08G 5/00

(52) U.S. Cl. CPC G08G 5/045; B64D 45/00; G08G 5/0021; B64D 2045/0075

(57) ABSTRACT

Example implementations relate to systems and techniques for intuitive hot spot demarcation along ground surfaces in order to provide alerts that assist pilots avoid potential collisions. An aircraft computing system may receive map and hot spot data for a taxi route for the aircraft. Based on the map and hot spot data, the computing system may display a representation of the taxi route with a graphical overlay that conveys a position of each hot spot located along the taxi route. The computing system may monitor movement of traffic relative to the taxi route based on traffic data. When traffic is detected proximate a hot spot located along the taxi route, the computing system may provide an alert via the display interface. The alert can increase in intensity based on the location of the traffic relative to the hot spot.

### FIELD

The present disclosure relates generally to preventing collisions on ground surfaces at airports, and more particularly to systems and techniques for displaying and monitoring hot spots along ground surfaces to assist pilots avoid potential collisions.

### BACKGROUND

Airport runways and taxi surfaces are crucial components of the infrastructure at an airport. In general, runways are long, straight strips of paved surfaces designed for safe aircraft takeoff and landing and are typically constructed with materials like asphalt or concrete to withstand the weight and impact of aircraft. The runways are usually aligned according to prevailing wind patterns and can vary in length and width to accommodate different types of aircraft. Taxiways connect runways to airport terminals, hangars, and maintenance areas and are often narrower than runways and marked with painted lines and signs to guide aircraft movement on the ground. Air Traffic Control (ATC) is tasked with maintaining safe spacing between aircraft and other vehicles as well as providing clearances for taxiing with holding points on taxiways used to enable aircraft to wait for clearance before entering the runway. Together, runways and taxiways enable the orderly and efficient movement of aircraft, facilitating the safe operation of airports.

### SUMMARY

In one example, a method is disclosed. The method involves receiving, at a computing system coupled to an aircraft, map and hot spot data for a taxi route for the aircraft and displaying, by the computing system and on a display interface, a representation of the taxi route based on the map and hot spot data. The representation includes a graphical overlay that conveys a position of each hot spot located along the taxi route. The method also involves monitoring, by the computing system and based on traffic data, movement of traffic relative to the taxi route and providing an alert via the display interface based on a detection of traffic proximate a hot spot located along the taxi route.

In another example, a system is disclosed. The system includes an airport mapping system, an aircraft, and a computing system. The computing system is configured to receive map and hot spot data for a taxi route for the aircraft and display, on a display interface, a representation of the taxi route based on the map and hot spot data. The representation includes a graphical overlay that conveys a position of each hot spot located along the taxi route. The computing system is also configured to monitor, based on traffic data, movement of traffic relative to the taxi route and provide an alert via the display interface based on a detection of traffic proximate a hot spot located along the taxi route.

In an additional example, a non-transitory computer-readable medium is described. The non-transitory computer-readable medium is configured to store instructions, that when executed by a computing system, causes the computing system to perform one or more of the functions of the above method.

The features, functions, and advantages that have been discussed can be achieved independently in various examples or may be combined in yet other examples further details of which can be seen with reference to the following description and drawings.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying drawings, wherein:

FIG. 1 illustrates a perspective view of an aircraft, according to an example implementation.

FIG. 2 is a block diagram of a computing system, according to an example implementation.

FIG. 3 is a system for displaying and monitoring hot spots along ground surfaces, according to an example implementation.

FIG. 4 is a flowchart of a method for displaying and monitoring hot spots along ground surfaces, according to an example implementation.

FIG. 5A illustrates a taxi route representation with a hot spot warning displayed, according to an example implementation.

FIG. 5B illustrates the taxi route representation with another hot spot warning displayed, according to an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

Conventional air traffic management at an airport typically involves the pilots of aircrafts receiving taxi and runway instructions from the ATC, which monitors air traffic, weather conditions, runway use, ground vehicles, flight schedules, and other factors to guide the use, selection, and movement of aircrafts and vehicles on the taxiways and runways. Airport complexity, approach patterns, airborne and surface traffic, low visibility, poor weather conditions, and on-time departure and arrival pressures are some factors that contribute to making taxi navigation challenging for pilots of an aircraft.

The incursion alerting system and other improvements in avionics technologies have helped improve the aviation safety record. Despite these improvements, however, situational awareness of the potential ground hazards still remains a significant safety issue. In particular, ground collisions between aircraft and other ground moving vehicles (including other aircraft) is one of the significant contributing sources of accidents in the aircraft transportation system. A majority of these ground collisions would occur at particular locations that are labeled “hot spots” and defined by the International Civil Aviation Organization (“CIAO”) as “a location on an aerodrome movement area with a history or potential risk of collision or runway incursion, and where heightened attention by pilots and drivers is necessary.” Due to the higher potential risks of collisions at these hot spots, there exists a need to alert and inform pilots about hot spot locations along taxi routes to increase airport safety and reduce collisions.

Example embodiments presented herein relate to methods and systems for intuitive hot spot demarcation, which involve identifying, displaying and monitoring hot spot information along the taxi path of an aircraft to help pilots safely navigate the taxi path and avoid ground-based collisions. By rendering hot spot locations along the ground route as part of an aircraft's cockpit primary display and/or an electronic flight bag (EFB) application, pilots and flight attendants on an aircraft can view hot spots and be alerted by warnings when traffic and the aircraft are located proximate a particular hot spot. In some implementations, the severity of the alert can depend on factors, such as the distance between the aircraft and traffic located nearby a hot spot. The shorter the distance and/or other factors (e.g., speed and orientation of the other vehicle relative to the aircraft) can increase the warning provided to the pilots and crew. In some cases, one or multiple threshold distances are used when evaluating which type of alert should be provided to the pilots of the aircraft or aircrafts. In some cases, the threshold distance(s) can depend on the size of a hot spot, length of aircraft wings, typical spacing used prior to an aircraft engaging in flight or crossing a runway, and/or other factors.

An example technique involves initially locating and displaying the hot spots positioned along the taxi path selected for an aircraft using information from one or multiple sources. For instance, an EFB device can receive aircraft position and traffic data, Notice to Airmen (NOTAM) information, airport, runway, and map data, and ATC clearance, which can enable the device to render visual representations for the hot spots positioned on ground surfaces at the airport. In some instances, the hot spots that are rendered can be limited to the particular hot spots located along the taxi route assigned to the aircraft that is using the EFB device.

Rendering and monitoring the hot spots can involve a variety of visual cues, text, and/or audio alerts. For instance, each hot spot can be represented on the EFB display interface or by another computing system on top of a map of the taxiways and runways with a graphical overlay, such as 2 concentric circles. The map can be augmented with graphics that clearly identify hot spots positioned at the airport. In the example, the first inner circle diameter can be less than the second outer circle diameter and may represent the wingspan of the aircraft. The second outer circle can represent the separation distance between two aircrafts maintained while the two aircrafts are lined up for take-off or waiting for clearance to cross intersection for landing aircraft.

As such, the technique further involves monitoring traffic data relative to the taxi path and the hot spots. Traffic data can tracked via Automatic Dependent Surveillance-Broadcast (ADS-B) and Airport Surface Detection Equipment (ASDE-X). If the traffic is identified within the first inner circle, the aircraft can be advised with an alert, such as a “RED-Warning” conveyed in the form of traffic signal symbol (e.g., a stop light) and/or coloring the inner circle perimeter with a color (e.g., RED) along with aural and text popup messages. The alerts can help inform the pilot(s) on the aircraft about the presence of some form of traffic (e.g., another aircraft) located relative to the hot spot positioned along the taxi route. In addition, the alerts can vary and may include one or more haptic, audio, and visual elements. The severity of the warning when the traffic is detected within the first inner circle has an increased intensity due to the shorter distance between the aircraft and the traffic detected within the hot spot. Similarly, when traffic is identified in the second outer circle, the technique involves providing a less severe alert, such as “AMBER-caution” alert that can inform the pilot. The “AMBER-caution” alert can be conveyed using similar visuals, audio, and/or haptics alerts as the severe “RED-Warning,” but with less intensity due to the farther distance between the aircraft and the detected traffic. By monitoring and alerting pilots regarding traffic relative to hot spot areas positioned along taxi routes, aircraft can avoid potential collisions during ground navigation, thereby increasing the safety of ground navigation by the aircraft and overall safety at the airport.

Disclosed techniques and systems can supplement conventional methods that are used to reduce ground collisions at airports. Although the ATC typically monitors and manually instructs all ground moving vehicles and aircraft and try to avoid collisions, example systems and techniques presented herein further enhance safety by identifying, rendering, and monitoring hot spots located along taxi routes assigned to aircraft and other vehicles. Graphics and alerts can be generated to keep pilots and crew aware of hot spots and nearby traffic located along taxi routes.

In some examples, detection of traffic within a threshold distance when traveling relative to a hot spot can trigger automatic action by the aircraft or ground vehicle utilizing the alert technology. For instance, an aircraft can automatically stop in situations when another aircraft or a ground vehicle is detected within a threshold distance of the aircraft and proximate to a hot spot. By highlighting hot spots and when traffic is nearby the aircraft relative to a hot spot, airports can reduce potential collisions and improve overall safety at the airport.

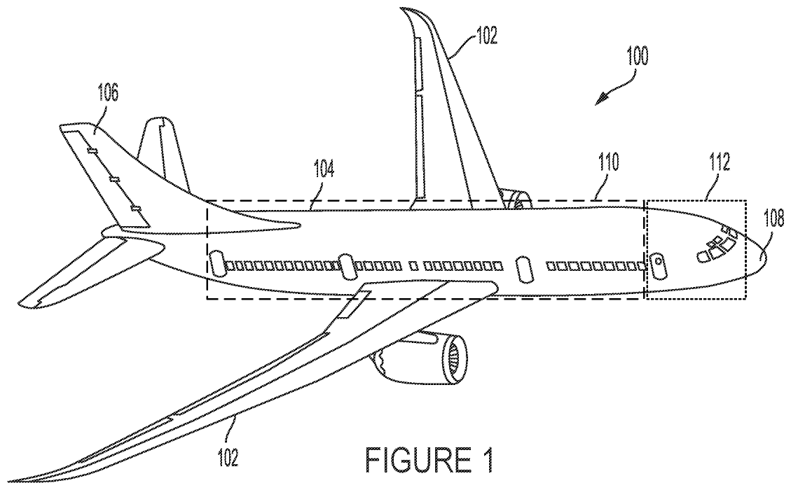

Referring now to the Figures, FIG. 1 illustrates a perspective view of an aircraft, according to an example implementation. The aircraft 100 is shown implemented with a set of wings 102, a fuselage 104, a tail 106, and a nose 108. In other embodiments, the aircraft 100 can have other configurations. The illustration in FIG. 1 also shows a position of a cabin 110 and a flight deck 112 of the aircraft 100. The cabin 110 and the flight deck 112, together collectively, make up the occupancy areas of the aircraft 100 where passengers and crew may occupy during flight. In particular, passengers may sit within the cabin 110 while pilots operate the aircraft from within the flight deck 112.

The aircraft 100 may include various subsystems or components that work together to ensure safe and efficient flight. For instance, the aircraft 100 includes an electrical system, which provides electrical power to the aircraft and can include generators, batteries, wiring, and various other electrical components. The aircraft 100 also includes a hydraulic system to power various components, such as landing gear, flaps, and brakes, and a fuel system to store and distribute fuel to the engines. The aircraft 100 further includes a navigation system that enables navigation and communication with air traffic control, a communication system to enable communication with other aircraft and the ground, and a flight control system to control the movement of the aircraft 100. In addition, the aircraft 100 also includes an environment control system to maintain a comfortable environment for passengers and crew by regulating temperature, humidity, and air quality. The aircraft also includes a landing gear system, an avionics system, and other systems.

The navigation system of the aircraft 100 can encompass a combination of onboard instruments and external references to determine the aircraft's position, track, and guidance during flight and ground navigation. The navigation system can include navigation aids like GPS, radio beacons (e.g., VOR beacon and a non-directional beacon (NDB)), inertial navigation systems, and radar systems. These systems provide data on the aircraft's location, heading, groundspeed, altitude, and distance to waypoints enabling pilots use this information along with aeronautical charts and instruments to navigate accurately along desired flight routes.

The pilots and crew of the aircraft 100 can also use an EFB system, which can be an electronic device or application that assists with various flight-related tasks. While the navigation system primarily focuses on determining the aircraft's position, track, and heading, an EFB serves as a multifunctional tool that integrates a range of functions beyond navigation and can provide features, such as digital charts, weather information, flight planning tools, performance calculations, documentation storage, communication capabilities, and more. As such, the navigation system of the aircraft 100 is dedicated to determining the aircraft's position and providing navigational guidance, while an EFB device can be used to incorporate additional functionalities to assist pilots with flight planning, charting, communication, and other operational tasks. EFBs leverage technology to enhance situational awareness and streamline various aspects of flight operations.

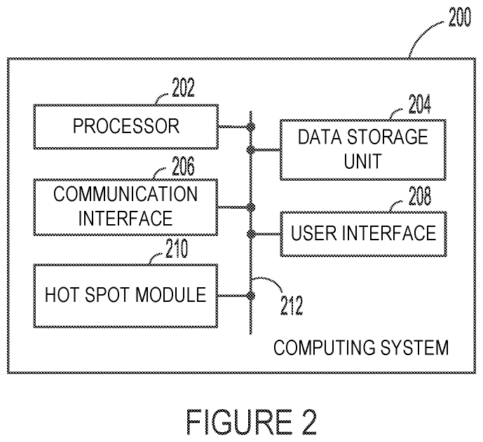

FIG. 2 is a block diagram of a computing system, according to an example implementation. The computing system 200 may perform various acts and/or functions, such as those described in this disclosure. For instance, the computing system 200 may correspond to an EFB device that can be used on the aircraft 100 shown in FIG. 1. In another example, the computing system 200 is part of the navigation system or another computing system.

As shown in FIG. 2, the computing system 200 may include various components, such as a processor 202, a data storage unit 204, a communication interface 206, a user interface 208, a hot spot module 210. The components can be connected to each other (or to another device, system, or other entity) via a connection mechanism 212, and can include more or fewer components in other example implementations. In other embodiments, the computing system 200 may be implemented across multiple computing devices operating within a network.

In addition, the computing system 200 can be located onboard an aircraft (e.g., the aircraft 100 shown in FIG. 1) or remotely from the aircraft or a combination of onboard and remote computing systems. For instance, the computing system 200 can perform disclosed operations onboard an aircraft. In this disclosure, the term “connection mechanism” means a mechanism that facilitates communication between two or more devices, systems, or other entities. For instance, a connection mechanism can be a simple mechanism, such as a cable or system bus, or a relatively complex mechanism, such as a packet-based communication network (e.g., the Internet). In some instances, a connection mechanism can include a non-tangible medium (e.g., where the connection is wireless).

The processor 202 may represent one or more general-purpose processors (e.g., a microprocessor) and/or one or more special-purpose processors (e.g., a digital signal processor (DSP)). As such, the processor 202 may include a combination of processors. The processor 202 may perform operations, including the processing of data received from the other components within the computing system 200 and of data obtained from external sources, such as sensors (e.g., aircraft sensors), other vehicles, and databases.

The data storage unit 204 may include one or more volatile, non-volatile, removable, and/or non-removable storage components, such as magnetic, optical, or flash storage, and/or can be integrated in whole or in part with the processor 202. As such, the data storage unit 204 may take the form of a non-transitory computer readable medium, having stored therein instructions executable (e.g., compiled or non-compiled program logic and/or machine code) that, when executed by the processor 202, cause the computing system 200 to perform one or more acts and/or functions, such as those described in this disclosure. Such program instructions can define and/or be part of a discrete software application. In some instances, the computing system 200 can execute program instructions in response to receiving an input, such as from the communication interface 206 or the user interface 208. The data storage unit 204 may also store other types of data, such as those types described in this disclosure.

In some examples, the data storage unit 204 may serve as a local storage for information obtained from one or more external sources. For example, the data storage unit 204 may store information obtained from sensors and/or databases. The data storage unit 204 can also store instructions executable by the processor 202 to perform functions of the computing system 200. For example, any of the modules or subsystems described herein may take the form of instructions executable by the processor 202 and the instructions can be stored on the data storage unit 204.

The communication interface 206 can allow the computing system 200 to connect to and/or to communicate with another entity (e.g., another computing device) according to one or more protocols. In an example, the communication interface 206 can be a wired interface, such as an Ethernet interface or a high-definition serial-digital-interface (HD-SDI). In another example, the communication interface 206 can be a wireless interface, such as a cellular or Wi-Fi interface. A connection can be a direct connection or an indirect connection, the latter being a connection that passes through and/or traverses one or more entities, such as a router, switcher, or other network device. Likewise, a transmission can be a direct transmission or an indirect transmission. The communication interface 206 may also utilize other types of wireless communication to enable communicating with one or more aircrafts and remote computing systems that can perform processing operations described herein.

The user interface 208 can enable one or more users (e.g., a pilot, crew) to interact with the computing system 200, including to enable input and analysis related to disclosed operations. For instance, the user interface 208 can provide alerts and/or other information based on detected nearby traffic and hot spots as disclosed herein. The alerts can include audio, visual, tactile, and/or other types of alerts. In some instances, the alerts can include text, audio-based text, and/or other visualizations. As such, the user interface 208 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 208 can include hardware and/or software components that facilitate interaction between the computing system 200 and one or more users.

The hot spot module 210 can enable the identification, rendering, and monitoring of hot spots on ground surfaces at an airport. For instance, the hot spot module 210 can identify hot spots positioned along a taxi route for the aircraft (e.g., the aircraft 100 shown in FIG. 1) based on information provided from one or multiple routes and subsequently render these hot spots on a display using one or more graphic elements, such as a pair of concentric circles. The hot spot module 210 can be used to monitor these hot spots and the position of traffic traveling nearby these hot spots. For instance, traffic data can be supplied by one or multiple sources, such as Automatic Dependent Surveillance-Broadcast (ADS-B) and Airport Surface Detection Equipment (ASDE-X). The hot spot module can provide alerts based on detected traffic and the proximity relative to the aircraft and the hot spot. The intensity of the alert can depend on factors, such as the speed, distance, and orientation of the detected traffic relative to the aircraft and a hot spot. In some cases, when multiple vehicles are detected proximate a hot spot and the aircraft, the alert can convey additional information, such as indicating the presence of the multiple vehicles nearby.

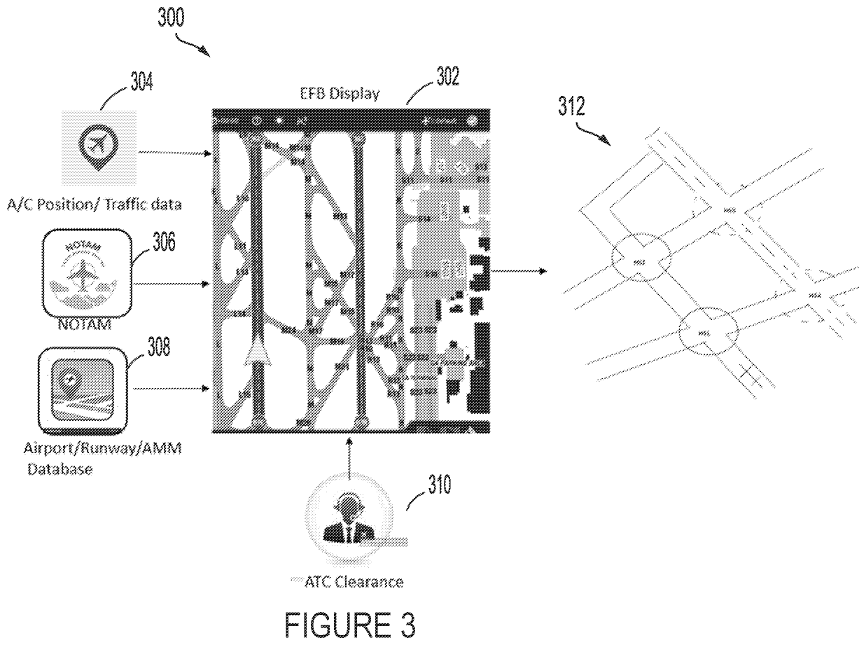

FIG. 3 shows a block diagram of a system for displaying and monitoring hot spots along ground surfaces. System 300 includes EFB device 302, aircraft position and traffic data 304, NOTAM 306, airport/runway/AMM database 308, ATC Clearance 310, and hot spot rendering 312. As such, system 300 represents various components that can perform operations described herein and can differ within other example implementations.

The EFB device 302 can be implemented similar to the computing system 200 shown in FIG. 2 and represents an electronic device or application used by pilots and flight crews to perform various functions related to flight operations. In general, EFB devices have replaced traditional paper-based materials, such as charts, manuals, and documents. As such, the EFB device 302 can perform disclosed operations and enable efficient and accessible information management.

The EFB device 302 can be various hardware platforms within examples, such as tablets, laptops, or dedicated devices specifically designed for aviation. The EFB device 302 can offer a wide range of features and capabilities, including flight planning, performance calculations, navigation, documentation, communication, and record keeping. The EFB device 302 can assist with flight planning tasks by providing access to weather information, airport data, navigation charts, and route planning tools. The EFB device 302 can also assist with performance calculations, such as takeoff and landing performance, weight and balance calculations, and fuel planning. The EFB device 302 can display electronic charts, including enroute charts, approach plates, and airport diagrams. The EFB device 302 can incorporate GPS and/or other navigation systems to provide real-time position information for an aircraft or ground vehicle. As such, the EFB device 302 can enable pilots to streamline operations, reduce paperwork, enhance situational awareness, and improve efficiency in the cockpit.

The EFB device 302 is shown receiving aircraft position and traffic data 304, which can include aircraft position data and traffic data provided from one or multiple sources, such as one or more databases, other vehicles and aircraft, onboard sensors, and/or remote sensors. In general, the aircraft position data can provide information about the location and movement of an aircraft (or multiple aircrafts), such as during flight. For instance, aircraft position and traffic data 304 can include the aircraft's geographical coordinates (i.e., latitude and longitude), altitude, heading, groundspeed, and other relevant parameters. As such, the aircraft position data can be used by ATC and flight operators to ensure the safe and efficient management of air traffic.

The aircraft position data can be obtained by the EFB device 302 through various sources. For instance, the aircraft is typically equipped with navigation system, which can use GPS or Global Navigation Satellite System (GNSS) receivers to obtain accurate position data for the aircraft. In addition, Automatic Dependent Surveillance-Broadcast (ADS-B) is a technology that enables aircraft to broadcast their position, velocity, and other information to ground-based receivers and other aircraft. This data is then used for air traffic surveillance and situational awareness. Radar systems used by ATC can also provide the position data for aircraft within their coverage area. For instance, primary radar detects the presence of aircraft by measuring the time it takes for radar signals to bounce off the aircraft, while secondary radar relies on transponder signals emitted by the aircraft to obtain additional information, such as identification and altitude data.

In addition to aircraft position data, the aircraft position and traffic data 304 also includes traffic data. The traffic data can indicate the presence and movement of other aircraft and vehicles in the vicinity of the aircraft. In practice, traffic data can allow pilots and air traffic controllers to be aware of nearby traffic and take appropriate measures to maintain safe separation and avoid collisions. Traffic data can be obtained through various means, such as Traffic Collision Avoidance System (TCAS), ADS-B, and radar. TCAS is an onboard system installed in most commercial aircraft that uses radio signals to communicate with other nearby aircraft equipped with TCAS, which enables information to be exchanged about their respective positions, altitudes, and velocities. TCAS can provide alerts and guidance to pilots to prevent potential mid-air collisions. Similarly, ADS-B technology that allows aircraft to broadcast their position and other information. ADS-B data can be received by other aircraft, as well as ground-based air traffic control systems, enabling situational awareness and traffic monitoring. Air traffic control radar systems provide surveillance of aircraft in a given airspace. Controllers can track aircraft and provide traffic information to pilots based on the radar data. Traffic data can also be supplied by ADS-B and ASDE-X. As such, traffic data is crucial for maintaining separation and ensuring safe operations, especially in areas with high traffic density such as airports, terminal areas, and enroute airspace. It can help pilots and air traffic controllers make informed decisions to avoid potential conflicts and maintain the required separation standards between aircraft. As such, the EFB device 302 can use the aircraft position and traffic data 304 when identifying, rendering, and monitoring hot spots. In particular, the EFB device 302 can monitor the movement of other aircraft and vehicles relative to its own position, which can include increased awareness around hot spots locate at the airport since these hot spots are identified based on higher risks of collisions.

The NOTAM 306 is also shown in FIG. 3 and represents a system used in aviation to disseminate important information to pilots and other aviation personnel regarding potential hazards, temporary changes, and/or significant events that may affect flight operations. The NOTAM 306 can provide timely and essential information to the EFB device 302 about various aspects of air navigation, which can then be used by the EFB device 302 to enhance pilot awareness and increase safety. For instance, the NOTAM 306 can be used to provide the EFB device 302 with changes in runway availability, taxiway closures, lighting malfunctions, fuel availability, or other airport-related issues. The NOTAM 306 can also provide updates of radio navigation aids, such as VHF omnidirectional range (VORs), non-directional beacons, or GPS equipment. The NOTAM 306 can provide information to the EFB device 302 related to airspace, such as data indicating temporary restrictions or changes to airspace usage. Weather related data, such as severe weather conditions, icing, thunderstorms, volcanic ash clouds, or other weather-related hazards can also be provided to the EFB device 302 by the NOTAM 306. In addition, the NOTAM 306 can provide changes to instrument approach procedures, departure or arrival routes, or other operational procedures at specific airports.

In general, NOTAMs are issued by aviation authorities, such as civil aviation authorities or air traffic control organizations. They are typically accessed by pilots and other aviation personnel through official channels, such as aviation websites, EFB applications, or briefing services. As such, pilots are responsible for reviewing relevant NOTAMs prior to a flight to ensure they are aware of any potential hazards or changes that may affect their planned route or destination. NOTAMs are typically classified by their significance and duration, with different types of NOTAMs denoting different levels of importance or urgency. By providing essential information, the NOTAM 306 can help pilots and aviation personnel make informed decisions and maintain the safety and efficiency of flight operations.

Airport/runway/AMM database 308 represents one or multiple databases that can provide additional data to the EFB system. For instance, the airport/runway/AMM database 308 can include an airport database, a runway database, and AMM database that may be part of the same database or separate databases. Regardless of configuration, the airport/runway/AMM database 308 can provide information to the EFB device 302 that aims to assist with aviation operations, maintenance, and safety.

In general, the airport database may contain comprehensive information about one or more airports, which can include airports located worldwide in some examples. For instance, the airport database can include data, such as the airport's name, location, elevation, runways, taxiways, navigation aids, communication frequencies, airport services, fuel availability, airport diagrams, and other relevant details. This information assists pilots and air traffic controllers in flight planning, navigation, and airport operations. As such, airport databases are utilized in various aviation systems and tools, such as flight management systems (FMS), EFB devices and applications, and air traffic control systems. The airport databases can ensure accurate and up-to-date information is available for efficient and safe flight operations.

A runway database is a subset of the airport database that focuses specifically on runways within airports and may provide detailed information about each runway, including dimensions, magnetic heading, surface type, runway lighting, approach aids (such as instrument landing systems or visual aids), displaced thresholds, and any runway-specific limitations or operational considerations. Pilots can use the runway data to plan takeoffs, landings, and navigation procedures based on the specific characteristics of each runway. Runway databases can help pilots ensure compliance with runway-related requirements, optimize aircraft performance, and adhere to safety procedures during takeoff and landing operations.

The AMM database can include a collection of technical documents and manuals specific to aircraft models or types. These manuals provide detailed instructions and procedures for aircraft maintenance, repairs, inspections, and troubleshooting. In general, AMMs can contain information on system descriptions, component removal and installation, maintenance tasks, servicing procedures, troubleshooting guides, and other pertinent maintenance-related data. They serve as a vital resource for maintenance technicians and engineers, which may ensure proper and standardized maintenance practices to maintain aircraft airworthiness and safety. The AMM databases are often managed by aircraft manufacturers or operators and are regularly updated to reflect the latest maintenance procedures, safety bulletins, and regulatory requirements.

ATC is a service provided by ground-based controllers who guide and manage aircraft movements to ensure safe and efficient air traffic operations. The primary responsibilities of ATC include maintaining separation between aircraft, issuing clearances and instructions, providing weather and traffic information, and managing the flow of air traffic within their designated airspace. As such, ATC controllers work from control towers at airports or enroute control centers to oversee different phases of flight, including departure, enroute navigation, and arrival/approach. The ATC controllers communicate with pilots using radio frequencies and adhere to standardized procedures and protocols.

ATC controllers can provide the ATC Clearance 310 to EFB device 302, which can represent the authorization given to an aircraft for a specific action or flight. The ATC Clearance 310 can enable the EFB device 302 to provide the pilot with instructions regarding the intended route, altitude, speed, and other relevant details necessary for the safe conduct of the flight. In general, ATC clearances can include various types. For instance, departure clearance is issued before an aircraft departs from an airport and contains instructions on the initial heading, altitude, and any specific departure procedures to be followed. The ATC Clearance 310 can also correspond to enroute clearance, which is typically given during the flight when the aircraft transitions from one airspace sector to another. The ATC Clearance 310 can include instructions on the route, altitude, and any restrictions or changes to be observed.

In some cases, the ATC Clearance 310 can also include approach clearance, which is provided as an aircraft approaches an airport for landing and may specify the runway to be used, any specific approach procedures, and clearance for descent and landing. In addition, ATC can also provide traffic separation clearance, which instructs an aircraft to maintain a specific distance or separation from other nearby aircraft to ensure safe spacing and avoid collisions. In general, ATC clearances are crucial for maintaining order and safety in the airspace. Pilots are required to adhere to these clearances and promptly inform ATC if unable to comply or if any deviations from the clearance become necessary due to safety concerns or unforeseen circumstances. The communication and cooperation between pilots and ATC are vital for the smooth and safe flow of air traffic.

The EFB device 302 or another computing system can receive information from the variety of sources shown as part of the system 300 in FIG. 3 in order to generate the hot spot rendering 312. In particular, the EFB device 302 can highlight hot spots positioned along taxi surfaces by using graphical overlays (e.g., circles or other visual cues) as shown in the hot spot rendering 312. Other visuals can be used to render the hot spots in other examples.

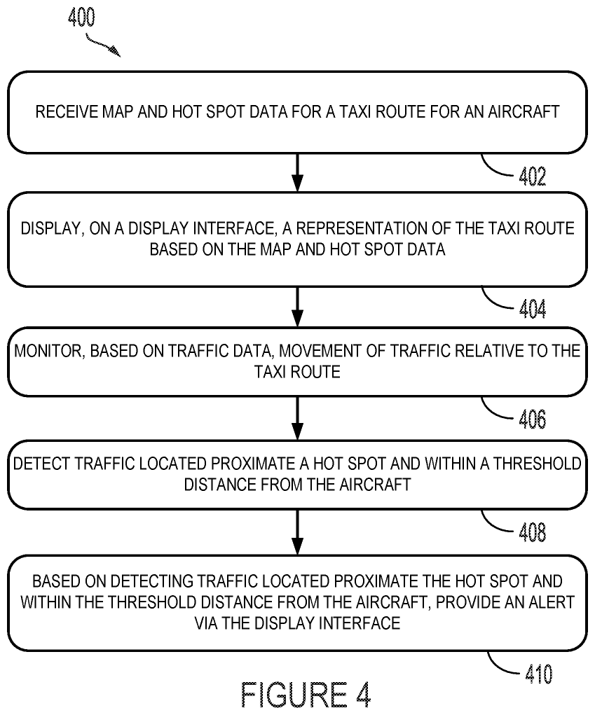

FIG. 4 shows a flowchart of a method, according to an example implementation. Method 400 presents an example method that could be used with the aircraft 100 shown in FIG. 1, the computing system 200 shown in FIG. 2, the system 300 shown in FIG. 3, and/or other devices and systems disclosed herein. For instance, the EFB device 302 can perform method 400 in some examples. In other examples, components of the devices and/or systems may be arranged to be adapted to, capable of, or suited for performing the functions, when operated in a specific manner.

Method 400 can include one or more operations, functions, or actions as illustrated by one or more of blocks 402, 404, 406, 408, and 410. Although the blocks are illustrated in a particular order, these blocks may also be performed in parallel, and/or in a different order than those described herein. Also, the various blocks may be combined into fewer blocks, divided into additional blocks, and/or removed based upon the desired implementation.

At block 402, method 400 involves receiving, at a computing system, map and hot spot data for a taxi route for an aircraft. For instance, the computing system may provide location data of the aircraft to an airport mapping system. The computing system can then receive the map and hot spot data for the taxi route from the airport mapping system. The airport mapping system can use the location data of the aircraft to identify the map and hot spot data for the taxi route. In some examples, the computing system is an EFB device or application.

At block 404, method 400 involves displaying, by the computing system and on a display interface, a representation of the taxi route based on the map and hot spot data. The representation includes a graphical overlay that conveys a position of each hot spot located along the taxi route. The display interface can enable the pilot (and potentially crew) of the aircraft to view hot spots located along the taxi route. In some cases, the computing system can be used to display the hot spots to ATC.

In some examples, the graphical overlay that conveys a position of a given hot spot includes a first inner circle located inside a second outer circle, where a diameter of the first inner circle is less than a diameter of the second outer circle. For instance, the diameter of the first inner circle can be based on a wingspan of the aircraft and the diameter of the second inner circle can be based on a separation distance between two aircrafts maintained while the two aircrafts are lined up for take-off or waiting for clearance to cross intersection for landing aircraft. In addition, on the display, the first inner circle can be represented by a first color and the second outer circle can be represented by a second color. The second color can differ from the first color. For instance, the first color can be represented by “Red” and the second color can be represented by “Amber”. Other colors and visuals can be used within examples.

At block 406, method 400 involves monitoring, by the computing system and based on traffic data, movement of traffic relative to the taxi route. For instance, the computing system can receive the traffic data representing movement of other aircraft and ground vehicles from ADS-B and/or ASDE-X. As such, the computing system can display the representation of the taxi route with the traffic data represented along the taxi route. In some cases, the traffic data is also received from one or more ground-based radars.

In some examples, the traffic data represents movement patterns for a plurality of aircraft. The computing system can display the representation of the taxi route with respective graphic aircraft visuals representing the movement patterns for the plurality of aircraft.

At block 408, method 400 involves detecting traffic located proximate a hot spot and within a threshold distance from the aircraft. In some cases, the computing system detects traffic located proximate or within the second outer circle of the hot spot and outside the first inner circle when the aircraft is positioned proximate or within the second outer circle of the hot spot. In other instances, the computing system detects traffic located proximate or within the first inner circle of the hot spot when the aircraft is positioned proximate or within the first inner circle of the hot spot.

At block 410, method 400 involves providing an alert via the display interface of the aircraft based on detecting traffic located proximate the hot spot and within the threshold distance from the aircraft. For instance, the computing system can determine that a given aircraft or vehicle is located proximate the second outer circle of the given hot spot based on the traffic data and then provide a first audiovisual alert via a navigation system or an EFB of the aircraft. In some cases, the computing system determines that the given aircraft or vehicle is located proximate the first inner circle of the given hot spot and provides a second audiovisual alert via the navigation system or the electronic flight bag of the aircraft. The second audiovisual alert represents a more severe alert than the first audiovisual alert. The computing system can display a text alert along with an audio alert via a navigation system or an EFB device or application.

In some cases, method 400 further involves receiving additional map and hot spot data for a modified taxi route for the aircraft and then displaying, on the display interface, a second representation of the modified taxi route based on the additional map and hot spot data. The second representation includes a second graphical overlay that conveys a position of each hot spot located along the modified taxi route.

In some examples, method 400 involves receiving image data depicting the taxi route from a camera coupled to the aircraft and augmenting the image data to include the graphical overlay that conveys the position of each hot spot located along the taxi route. Method 400 can further involve detecting an aircraft or ground vehicle is proximate the hot spot based on subsequent image data from the camera during ground navigation by the aircraft.

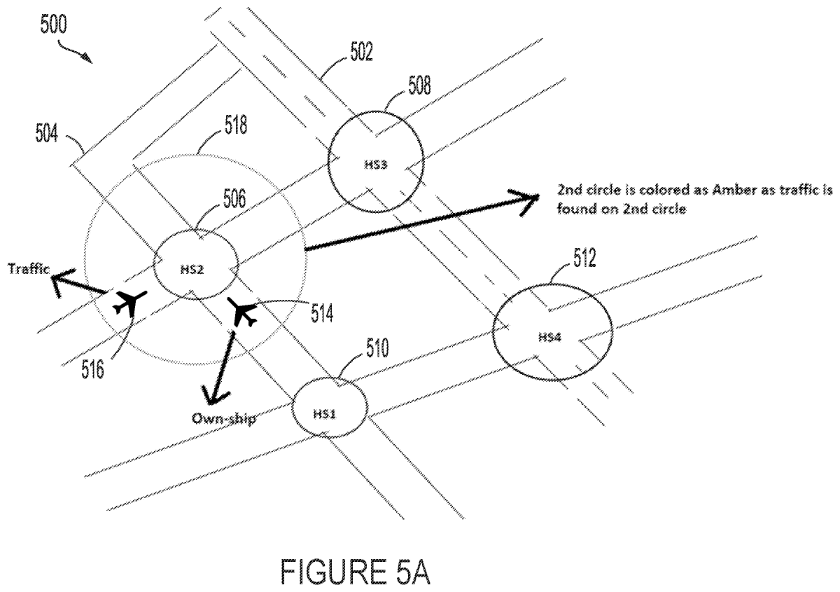

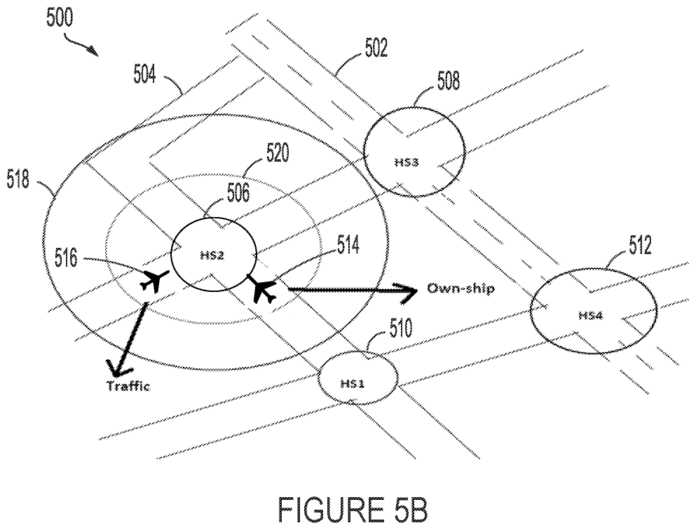

FIG. 5A illustrates a taxi route representation 500 with a hot spot warning displayed. The taxi route representation 500 corresponds to a map of the airport with runways 502, taxiways 504 shown. In addition, the taxi route representation 500 also shows hot spot 506, hot spot 508, hot spot 510, and hot spot 512, which provides additional insight to the pilots and crew of the aircraft 514 using the taxi route representation 500.

In the example scenario shown in FIG. 5A, the aircraft 514 using the taxi route representation 500 is shown approaching hot spot 506. At the same time, traffic 516 is shown approaching the hot spot 506 as well. In particular, traffic 516 is an aircraft that is shown traveling toward the hot spot 506, which causes the traffic 516 and the aircraft 514 to be located within a threshold distance from each other represented by graphical circle 518. As an example result, the taxi route representation 500 further shows the hot spot warning, which colors the graphical circle 518 that is encompassing both the aircraft 514 and the traffic 516 to alert the pilot and crew of the aircraft 514. For instance, the computing system assisting the pilots of the aircraft 514 can provide an alert that highlights the traffic with a color (e.g., amber) and/or a unique symbol, such as a traffic signal that displays yellow color conditions with the appropriate text and aural messages. The traffic 516 may obtain a similar alert using similar hot spot warning technology.

FIG. 5B illustrates the taxi route representation 500 with another hot spot warning displayed. In the example scenario shown in FIG. 5B, the aircraft 514 and the traffic 516 are shown positioned closer to the hot spot 506, and thus are positioned closer to each other. As further shown, the taxi route representation 500 depicts both the outer graphical circle 518 and a graphical inner circle 520. Both the traffic 516 and the aircraft 514 are located in the graphical inner circle 520 in the example scenario, which can trigger a higher (e.g., more severe) alert to warn the pilot of the aircraft 514 of the proximity between the aircraft and the traffic 516. For instance, a computing system can generate a “Warning” alert that can be represented by a different color, such as red, to capture the attention of the pilot of the aircraft 514.

By the term “substantially” or “about” used herein, it is meant that the recited characteristic, parameter, or value need not be achieved exactly, but that deviations or variations, including for example, measurement error, measurement accuracy limitations, friction, and other factors known to skill in the art, may occur in amounts that do not preclude and/or occlude the effect the characteristic was intended to provide.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. A method comprising:
receiving, at a computing system coupled to an aircraft, map and hot spot data for a taxi route for the aircraft;
displaying, by the computing system and on a display interface, a representation of the taxi route based on the map and hot spot data, wherein the representation includes a graphical overlay that conveys a position of each hot spot located along the taxi route;
monitoring, by the computing system and based on traffic data, movement of traffic relative to the taxi route;
detecting traffic located proximate a hot spot and within a threshold distance from the aircraft; and
based on detecting traffic located proximate the hot spot and within the threshold distance from the aircraft, providing an alert via the display interface.

2. The method of claim 1, further comprising:
receiving additional map and hot spot data for a modified taxi route for the aircraft; and
displaying, on the display interface, a second representation of the modified taxi route based on the additional map and hot spot data, wherein the second representation includes a second graphical overlay that conveys the position of each hot spot located along the modified taxi route.

3. The method of claim 1, further comprising:
providing location data of the aircraft to an airport mapping system; and
wherein receiving the map and hot spot data for the taxi route for the aircraft comprises:
receiving the map and hot spot data for the taxi route from the airport mapping system, wherein the airport mapping system uses the location data of the aircraft to identify the map and hot spot data for the taxi route.

4. The method of claim 1, wherein the graphical overlay that conveys a position of the hot spot comprises:
a first inner circle located inside a second outer circle, wherein a diameter of the first inner circle is less than a diameter of the second outer circle.

5. The method of claim 4, wherein the diameter of the first inner circle is based on a wingspan of the aircraft and the diameter of the second outer circle is based on a separation distance between two aircrafts maintained while the two aircrafts are lined up for take-off or waiting for clearance to cross intersection for landing aircraft.

6. The method of claim 4, wherein the first inner circle is represented by a first color and the second outer circle is represented by a second color, and wherein the second color differs from the first color.

7. The method of claim 4, wherein detecting traffic located proximate the hot spot and within the threshold distance from the aircraft comprises:
detecting traffic located proximate or within the second outer circle of the hot spot and outside the first inner circle when the aircraft is positioned proximate or within the second outer circle of the hot spot; and
providing a first audiovisual alert via a navigation system or an electronic flight bag.

8. The method of claim 7, further comprising:
detecting traffic located proximate or within the first inner circle of the hot spot when the aircraft is positioned proximate or within the first inner circle of the hot spot; and
providing a second audiovisual alert via the navigation system or the electronic flight bag, wherein the second audiovisual alert represents a more severe alert than the first audiovisual alert.

9. The method of claim 1, further comprising:
receiving the traffic data representing movement of other aircraft and ground vehicles from Automatic Dependent Surveillance-Broadcast (ADS-B) and Airport Surface Detection Equipment (ASDE-X); and
wherein displaying the representation of the taxi route based on the map and hot spot data comprises:
displaying the representation of the taxi route with the traffic data represented along the taxi route.

10. The method of claim 1, further comprising:
receiving traffic data for the taxi route for the aircraft, wherein the traffic data represents movement patterns for a plurality of aircraft; and
displaying the representation of the taxi route with respective graphic aircraft visuals representing the movement patterns for the plurality of aircraft.

11. The method of claim 1, wherein providing the alert comprises:
displaying a text alert along with an audio alert via a navigation system or an electronic flight bag.

12. The method of claim 1, further comprising:
receiving image data depicting the taxi route from a camera coupled to the aircraft; and
wherein displaying the representation of the taxi route based on the map and hot spot data comprises:
augmenting the image data to include the graphical overlay that conveys the position of each hot spot located along the taxi route.

13. The method of claim 12, wherein detecting traffic located proximate the hot spot and within the threshold distance from the aircraft comprises:
detecting another aircraft or ground vehicle is located proximate the hot spot and within the threshold distance from the aircraft based on subsequent image data from the camera during ground navigation by the aircraft.

14. A system comprising:
an airport mapping system;
an aircraft; and
a computing system configured to:
receive map and hot spot data for a taxi route for the aircraft;
display, on a display interface, a representation of the taxi route based on the map and hot spot data, wherein the representation includes a graphical overlay that conveys a position of each hot spot located along the taxi route;
monitor, based on traffic data, movement of traffic relative to the taxi route;
detect traffic located proximate a hot spot and within a threshold distance from the aircraft; and
based on detecting traffic located proximate the hot spot and within the threshold distance from the aircraft, provide an alert via the display interface.

15. The system of claim 14, wherein the graphical overlay that conveys the position of a given hot spot comprises:
a first inner circle located inside a second outer circle, wherein a diameter of the first inner circle is less than a diameter of the second outer circle.

16. The system of claim 15, wherein the computing system is configured to:
based on detecting traffic located within the second outer circle and outside the first inner circle, provide a caution alert that includes text, audio, and applies a color to the second outer circle on the representation of the taxi route.

17. The system of claim 16, wherein the computing system is configured to:
based on detecting traffic located within the first inner circle, provide a warning alert that includes text, audio, and applies a different color to the first inner circle on the representation of the taxi route.

18. The system of claim 14, wherein the traffic data is received from Automatic Dependent Surveillance-Broadcast (ADS-B) and one or more ground-based radars, and wherein the traffic data represents movement of other aircraft and ground vehicles.

19. The system of claim 14, wherein the computing system is an electronic flight bag device.

20. A non-transitory computer readable medium configured to store instructions, that when executed by a computing system, causes the computing system to perform operations comprising:
receiving map and hot spot data for a taxi route for an aircraft;
displaying, on a display interface, a representation of the taxi route based on the map and hot spot data, wherein the representation includes a graphical overlay that conveys a position of each hot spot located along the taxi route;
monitoring, based on traffic data, movement of traffic relative to the taxi route;
detecting traffic located proximate a hot spot and within a threshold distance from the aircraft; and
based on detecting traffic proximate the hot spot and within the threshold distance from the aircraft, providing an alert via the display interface.
